(19) United States
(12) Patent Application Publication
(10) Pub. No.: US 2019/0371166 A1
(43) Pub. Date: Dec. 5, 2019

(54) 2-D Traffic Control Method

(71) Applicant: Weiping Meng, Flushing, NY (US)

(72) Inventor: Weiping Meng, Flushing, NY (US)

(21) Appl. No.: 16/472,855

(22) PCT Filed: Dec. 22, 2016
(86) PCT No.: PCT/CN2017/000745

§ 371 Date: Aug. 19, 2019

(30) Foreign Application Priority Data
Dec. 22, 2016 (CN) 201611200128.8

(51) Int. Cl. G08G 1/082; G08G 1/087; G08G 1/01; G08G 1/095

(52) U.S. Cl. CPC G08G 1/082; G08G 1/095; G08G 1/0145; G08G 1/087

(57) ABSTRACT

The invention relates to a traffic signal mode field, discloses method enabling traffic signal running greenwave in the two cross direction within the whole roadnet, the control method comprises the following steps: calculating the allocation ratio mode with obtaining the set-driving-time of road-segments; calculation of the 2-D greenwave-offset on the corner-intersection of the roadnet; run RATIO mode after the 2-D greenwave-offset run out. The invention can make the same directional flow (isotropic) with the characteristics of the medium flow traffic load reduce waiting-time for more than 15% compared with the 1-D greenwave signal mode to, reduce greater than 30% compared with the ratio of signal to, and reduce more waiting-time further if adjusting signal-mode to matching traffic flow characteristics, and greatly improve the efficiency of transportation.

### CROSS REFERENCE TO RELATED APPLICATIONS

(Not Applicable)

### FEDERALLY SPONSORED RESEARCH/DEVELOPMENT

(Not Applicable)

### BACKGROUND OF THE INVENTION

### Technical Field and Prior Art

The present invention relates generally to a method for traffic control, particularly to 2-dimension control method of traffic signal network.

Currently the most common traffic control method for road network are: RATIO and GREENWAVE.

RATIO means the ratio of cross-directions' permit-time: given a signal period, select a direction as main direction and its time as numerator, the cross directions are distributed with the rest time of the period, so the ratio=main-direction time/cross-direction time, makes traffic have to get permit/stop based on the ratio periodically. GREENWAVE partially solves the problem. GREENWAVE is based on RATIO: firstly setup time ratio of two cross-directions on every intersections in roadnet with MxN intersections, which forms a quazi-rectangle area with M columns of channels and N rows of channels, secondly select an edge of the rectangle as start-edge and every intersection on the edge as 0-offset intersection in the direction pointing to entering-the-area, that 0-offset intersection are called as start-intersection of greenlight of whole roadnet, then from the start-intersections on one by one downstream intersection in the entering-the-area direction add one more time-offset for their greenlight-start than the time-offset of its immediately upstream intersection, obtaining an increasing offset for each downstream adjacent intersection, so as to start green signal one by one intersections with its offset decreasing to 0, forming area one-dimension greenwave, that's surge-greenwave; Only one channel running greenwave is called as channel-greenwave. Surge-greenwave consists of multiple channel-greenwaves. The sum of the time-offset of every two adjacent intersections along a channel from start-intersection to a downstream one is the intersection greenwave time-offset of the downstream one, in fact, the intersection greenwave time-offset of a downstream intersection to its channel upstream edge start-intersection is the sum of vehicle-set-driving-time on every road-segment between adjacent intersections from the start-intersection to the downstream intersection. The object of GREENWAVE is to make vehicle-flow meet green signal at its arrival and so obtains whole channel green signals, which greatly decreases waiting-time of the vehicles; only can such mode, however, operates in parallelly. It could further decrease vehicle waiting-time if greenwave run in a crossing direction meanwhile.

### BRIEF SUMMARY OF THE INVENTION

It is an object of the present invention to run greenwave in two cross directions in roadnet, so as to further decrease vehicle waiting-time and improve traffic efficiency.

In keeping with the object, the features of the present invention is as follow:

A method for 2-dimension, denoted by 2-D, greenwave mode in road traffic signal network includes steps of:
S1: Setting RATIO as initial state with obtaining parameters of road-segments of roadnet;
   Said roadnet is comprised of MxN intersections forming quazi-rectangle, M channels in column, called col-channel, N channels in row, called row-channel; said road-segment is the road between two adjacent intersections; said parameters includes the vehicle driving time through the road-segment at a set-speed, named as set-driving-time, which is the length of the road-segment/the set-speed;
S2 setting intersection greenwave time-offset for every intersection in the roadnet for two cross directions referring to the intersection at a corner of the rectangle, called as intersection 2-D greenwave-offset, which is sum of the surge-greenwave offset of the roadnet, called as master directional channel greenwave-offset of intersection, where said corner intersection is one of the start-intersections of the surge-greenwave, which flow direction is called master greenwave direction, and slave greenwave-offset, called as slave directional channel greenwave-offset of intersection, which also refers to the said corner intersection as start-intersection in a cross direction over the master direction, along which channel are the start intersections of the aforementioned master channel;
S3 run RATIO mode after running out the 2-D greenwave-offset with red-light-on or without signals;

Another feature of the present invention is that step S1 includes steps of:
S11 aforementioned set-driving-time minus braking-to-stop-time at set-speed;

Another feature of the present invention is that step S1 includes steps of:
S12 aforementioned set-driving-time minus larger one of set-speed braking-to-stop-time and vehicle-starting-to-move-time;

Another feature of the present invention is that step S3 includes steps of:
S31 aforementioned running out the 2-D greenwave-offset means decreasing the offset second by second to zero;

Another feature of the present invention is that step S3 includes steps of:
S32 aforementioned running out the 2-D greenwave-offset means increasing a value second by second from zero to the offset;

Note 1: Said an intersection is an influx of multi-directional road-segments, controlled by corresponding traffic signals network, 1) a road-segment means a road between two adjacent intersections. 2) channel means multi-tandem-connected road-segments, a channel from one side of roadnet directly to the other side without intersection-turn is direct channel, denoted by D-channel;

Note 2: Said features of roadnet includes number of intersections controlled, distance and set-driving-time of road-segments, distribution of the intersections; set-driving-time means time that vehicle drives at set-speed from one end of a road-segment to the other end; roadnet with M*N intersections, denoted by {M, N} or {(0, 0), (M−1, N−1)}, which (#, #) represents the intersection coordinates, M columns of D-channel, or said M col-D-channels, N rows of D-channel, or said N row-D-channels; column-road-segments denoted {M, N−1} {==}, represents the total number M of columns of D-channels, each col-D-channel including N−1 road-segments, the m-th col-D-channel with the set of set-driving-time of every road-segments of the col-D-channel denoted as m “==” representative for the corresponding values of road-segments of (N−1) columns; row-road-segments denoted {N, M−1} {==}, represents the total number N of rows of D-channels, each row-D-channel including M−1 road-segments, the n-th row-D-channel with the set of set-driving-time of every road-segments of the row-D-channel denoted as n “==” representative for the corresponding values of road-segments of (M−1) rows; the total number of road-segments at least N*(M−1)+M*(N−1); the values including the length, set-move-time, or, fixed, etc; it is not a must for absolute parallelism of road-segments.

Note 3: Said directional channel greenwave-offset of intersection is sum of all road-segments' set-driving-time from greenwave start-intersection to the downstream intersection in reversed-greenwave-direction in the set of set-driving-time of a channel, denoted by d#{*}, which are from said {M, N−1} or {N, M−1} {==} inserted with 0 set-driving-time of column or row for greenwave start-intersection, “d” represents direction of greenwave, N/North, E/East, S/South, W/West, etc, “#” represents coordinates of an intersection, that's, d#{*}=>d(i, j){*}, such as N(6, 2){0, ==} represents intersection (6, 2) of North-flow green-wave in roadnet and the most-south (i.e., the reserved North) end intersection as start-intersection with set-driving-time 0, “==” is the set of set-driving-time of all road-segments in the channel; for D-channel, “#” represents serial number of a D-channel, such as W1 {==, 0} representing that west-flow greenwave in roadnet and the most-east (i.e., the reserved west) end intersection as start-intersection with set-driving-time 0 and all intersections with j=1; well, S4{==, 0} representing that south-flow greenwave in roadnet and the most-north (i.e., the reserved south) end intersection as start-intersection with set-driving-time 0 and all intersections with i=4.

The advantages of the present invention are below: simulation with 5×5 roadnet shows 2-D greenwave signals mode decreases by 15% wait-time of traffic under isotropical traffic load compare to 1-D greenwave mode, by 30% to RATIO mode; if traffic signal mode match traffic mode, it greatly decreases further the wait-time and improves efficiency of traffic.

### BRIEF DESCRIPTION OF THE DRAWINGS

FIG. 1 is a roadnet running 2-D greenwave;

FIG. 2 is structure of roadnet with traffic signal control system and 2-D greenwave offset setting and running;

FIG. 3 is flowchart of 2-D greenwave control method;

### LIST OF REFERENCE NUMERAL UTILIZED IN THE DRAWING

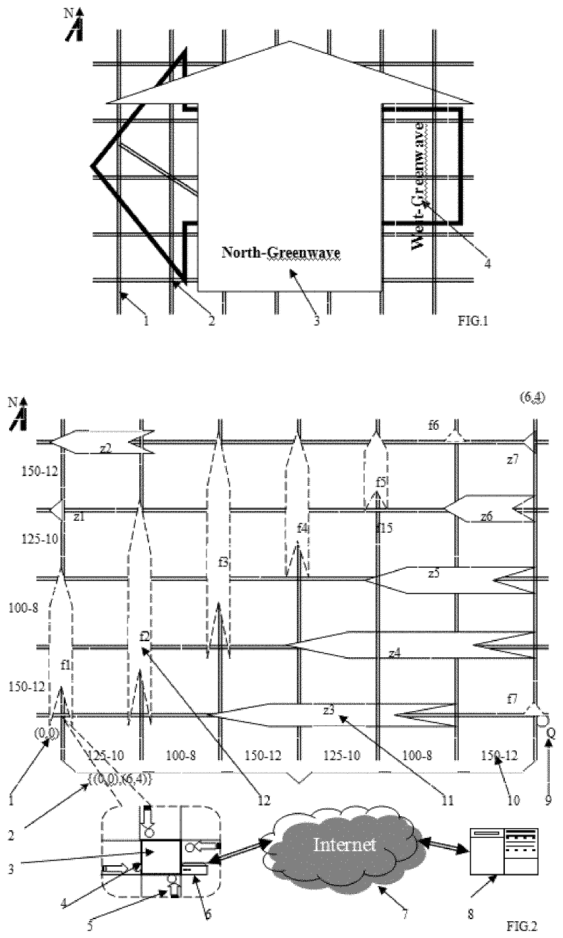

In FIG. 1:

1—roadnet, 2—intersection, 3—north greenwave in 7^{th} col.-D-channel, 4—west greenwave in 5^{th} row-D-channel;

In FIG. 2:

1—origin of roadnet and intersection coordinates with (0, 0) at lower-left corner; 2—roadnet mark {(0, 0), (6, 4)}; 3—intersection; 4—traffic signals; 5—vehicle queue; 6—traffic signals controller; 7—internet; 8—control system center; 9—mark for 2-D origin “Q” with small octagon; 10—“#-#” is for two values: distance, set-driving-time, at speed 45 km/h; 11—master greenwave flow direction signed with solid line arrow pointing at left-west, occurred at third, denoted by z3, z1 at most-left is the first-occurred master greenwave leaving; 12—the second slave greenwave flow direction signed with dotted line arrow pointing at up-north, occurred at second, denoted by f2, f7 at lower-right corner is the 7th-occurred slave greenwave occurring, immediately after the green light of the master greenwave turning into red light; meanwhile, the length of master/slave greenwave signs of solid/dotted line arrow represents an estimate of greenwave time, such as the length of f2 representing about 30 seconds, z5 about 20 seconds

### DETAILED DESCRIPTION OF THE INVENTION

### Description of the Preferred Embodiments, Industry Applications

A detailed description of an embodiment of the invention in conjunction with the accompanying drawings:

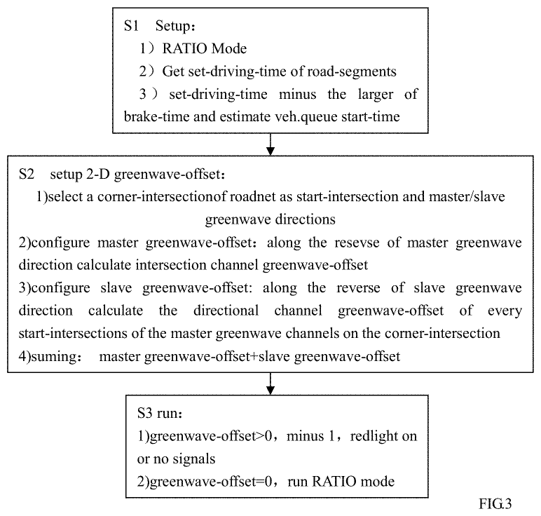

Create a network as shown in FIG. 2, where label 2-3 is an intersection, 2-4 is crossing the intersection traffic flow, 2-5 is a straight-left two phase signal or with a traffic signal machine or equipped with sensors in 2-6, controlled through the communication network in 2-7 from the center control system in 2-8 which produces, executes the 2-D greenwave control methods such as FIG. 3;

In FIG. 2, the features of roadnet included: the node coordinates of intersection in label 2-1 (0, 0) as origin node in the lower left corner of roadnet {(0, 0), (6, 4)} or {7, 5} in 2-2, which has a total of 35 intersections, 7 north-south col.-D-channels and 5 East-West row-D-channels, the set of set-driving-time of the col-D-channels {7, 4} {==} for 28 corresponding south-north road-segments of the col-D-channels, the set of set-driving-time of the row-D-channels {5, 6} {==} for 30 corresponding east-west road-segments of the row-D-channels, the “#-#” as shown in 2-10 for each road-segments, its length # and its set-driving-time #, according to the speed at 45 kilometers as set-speed, for an example, from intersection (5, 0) to (6, 0), the distance of 150 meters, the set-driving-time of 12 seconds, from intersection (5, 2) to (5, 3), 125 meters, 10 seconds;

In FIG. 2, the feature parameters and set up for 2-D greenwave including: the slave flow direction greenwave start-intersection (6, 0) in label 2-9; the master greenwave flow direction is west, as shown in z#2-11; the slave greenwave flow direction is north, as shown in f#2-12; the set of the start-intersections of the master greenwave is col6N, the set of the set-driving-time of master greenwave channel, including: from W0{*} to W4{*}, for all row-D-channels {*} are {10, 8, 12, 10, 8, 12, 0}, in which the most-right value 0 is inserted as the set-driving-time for the start-intersection of the master greenwave, the other 6 values come from {5, 6} {==}; the set of the set-driving-time of slave greenwave channel: N6{*}={0, 12, 8, 10, 12}, in which the most-left value 0 is inserted as the set-driving-time of the start-intersection of the slave greenwave, the other 4 values come from the corresponding 6^{th} column in {7, 4} {==}; the 2 amendment time for road-segments considered: braking time of 2 seconds of vehicle at speed 30 km per hour, and experience-acquired start time of estimate mean 3 seconds of 3 vehicles queue [note 1], reduce the larger, then, the corrected set of the set-driving-time of the master greenwave channel from W 0 to W 4 N={7, 5, 9, 7, 5, 9, 0}, the corrected set of the set-driving-time of the slave greenwave channel: North 6 N={0, 9, 5, 7, 9}; 2-D greenwave-offset of an interection=its master channel greenwave-offset+its slave channel greenwave-offset, for example, to the intersection (2, 3), 2-D greenwave-offset=[9+7+5+9+0]+[0+9+7+5]=30+21=51, to the intersection (0, 4), 2-D greenwave-offset=[7+5+9+7+5+9+0]+[0+9+7+5+9]=42+30=72, for the start-intersection (6, 0) of slave greenwave: [0]+[0]=0;

Note 1: the experience-acquired start time of estimate mean 3 seconds of 3 vehicles queue refers to the time for the last vehicle at 3 vehicle queue in the moving direction same as greenwave direction from getting with green signal and starting to the time required for normal driving.

In FIG. 2, the 2-D greenwave control method comprises the steps of feature:
S1 setup default ratio signal mode: (1) set north as signal main direction for all intersection in roadnet, cycle=90 seconds, the time ratio for directions=1, each direction for 45 seconds, straight-left 2-phase ratio=2, straight phase for 30 seconds, left phase for 15 seconds; (2) and get a rectangle from the roadnet, including 7×5 intersections with 7 col.-D-channels and 5 row-D-channels, and the set-driving-time of every road-segments of the channels, i.e., the length of the road-segment divided by set-speed, then subtract the corresponding braking time;
S2: calculate and configure 2-D greenwave-offset: 1) setup master/slave greenwave flow directions, 2) setup master greenwave time-offset: calculate and configure master directional channel greenwave-offset of intersection for every intersection in master directional channels, 3) setup slave greenwave time-offset: calculate and configure intersection directional channel greenwave-offset for every start-intersections of the master directional greenwave channels along the slave greenwave direction, 4) calculate and configure 2-D greenwave-offset for each intersection: the master directional channel greenwave-offset of an intersection + the slave greenwave-offset of the start-intersection of the master directional greenwave channel in which the being-configured intersection resides;
S3: run out the 2-D greenwave-offset of each intersection with Red signal on or without signal light first, then run RATIO mode, that's: for each intersection, if 2-D greenwave-offset >0, display Red signal or no signal, and minus 1, wait for seconds, until the 2-D greenwave-offset=0, begin to implement RATIO mode.

What is claimed as new and desired to be protected by Letters Patent is set forth in the following:

1. A method for roadnet traffic signals 2-Dimension control includes the steps of:
S1: Setting RATIO as initial state with obtaining parameters of road-segments of roadnet;
Said roadnet is comprised of M×N intersections forming quazi-rectangle, M channels in column, called col-channel, N channels in row, called row-channel; said road-segment is the road between two adjacent intersections; said parameters includes the vehicle driving time through the road-segment at a set-speed, named as set-driving-time, which is the length of the road-segment/the set-speed;
S2 setting intersection greenwave time-offset for every intersection in the roadnet for two cross directions referring to the intersection at a corner of the rectangle, called as intersection 2-D greenwave-offset, which is sum of the surge-greenwave offset of the roadnet, called as master directional channel greenwave-offset of intersection, where said corner intersection is one of the start-intersections of the surge-greenwave, which flow direction is called master greenwave direction, and slave greenwave-offset, called as slave directional channel greenwave-offset of intersection, which also refers to the said corner intersection as start-intersection in a cross direction over the master direction, along which channel are the start intersections of the aforementioned master channel;
S3 run RATIO mode after running out the 2-D greenwave-offset with red-light-on or without signals;

2. A method as defined in claim 1, wherein step S1 includes the steps of:
S11 aforementioned set-driving-time minus braking-to-stop-time at set-speed;

3. A method as defined in claim 1, wherein step S1 includes the steps of:
S12 aforementioned set-driving-time minus larger one of set-speed braking-to-stop-time and vehicle-starting-to-move-time;

4. A method as defined in claim 1, wherein step S3 includes the steps of:
S31 aforementioned running out the 2-D greenwave-offset means decreasing the offset second by second to zero;

5. A method as defined in claim 1, wherein step S3 includes the steps of:
S32 aforementioned running out the 2-D greenwave-offset means increasing a value second by second from zero to the offset;
